(19) United States
(12) Patent Application Publication
(10) Pub. No.: US 2022/0078976 A1
(43) Pub. Date: Mar. 17, 2022

(54) PROCESS FOR RELIABLE DETECTION OF THE TOP EDGE OF THE HEADING FACE OF A PILE OF PRODUCT(S) FOR ANIMAL FEEDING, FROM AN EXTRACTION VEHICLE AND SUCH A VEHICLE FOR IMPLEMENTING SAID PROCESS

(71) Applicant: KUHN-AUDUREAU SAS, La Copechagniere (FR)

(72) Inventors: Adrien LEGRAND, La Roche-Sur-Yon (FR); Léandre GUIDAULT, La Roche-Sur-Yon (FR)

(73) Assignee: KUHN-AUDUREAU SAS, La Copechagniere (FR)

(21) Appl. No.: 17/447,493

(22) Filed: Sep. 13, 2021

(30) Foreign Application Priority Data
Sep. 14, 2020 (FR) 20 09281

(51) Int. Cl. A01F 25/20; G01S 17/08; G01S 7/481

(52) U.S. Cl. CPC A01F 25/2027; A01F 2025/2063; G01S 7/4817; G01S 17/08

(57) ABSTRACT

A process for reliable detection of the top edge of the heading face of a pile of product(s) for animal feeding, from an extraction vehicle. It consists of positioning the vehicle in front of the heading face, then continuously controlling the upward motion of the extraction arm so as to vertically scan the plane of the heading face with the axes of measurement of at least two measurement sensors, then, as soon as at least any information is acquired indicating the absence of target, ordering the motion of the arm to stop, possibly ordering the detection of presence of an obstacle on the pile of product(s), then ordering the actuation of the extraction tool. Its object is also such a vehicle for implementing the process.

The present invention relates to the field of agricultural mechanization, and more particularly extraction vehicles/machines for loading and/or distribution of product(s) intended for animal feeding and its object is a process for reliable detection of the top edge of the heading face of a pile of product(s) for animal feeding, from an extraction vehicle. Its object is also such a vehicle for implementing said process.

An extraction vehicle, also known by the name of unloader, is a mobile agricultural machine used to extract or load at least one product, such as feed, stored or stockpiled in the form of a pile of product(s), generally stored in a silo, for its distribution to animals for feeding them. Generally, this type of vehicle also makes it possible to distribute the extracted products to the animals.

The vertical face of the pile of product(s) where the extraction is done is commonly called the heading face and is delimited at its top by a top edge which constitutes a starting point of the extraction.

Such an extraction vehicle comprises a chassis supporting a vessel able to receive the extracted product and an extraction arm for extraction and loading of the product into the vessel. Generally, the vessel is equipped with a mixing device for mixing the extracted products before its (their) distribution and also comprises means of distribution making it possible to distribute the product(s) contained in said vessel.

The loading arm comprises an extraction tool making it possible to extract the product in the pile of product(s) and a transfer device for the transport of the product extracted by said extraction tool into the vessel. The extraction tool generally consists of a rotary tiller which extends horizontally and perpendicularly to the longitudinal axis of the agricultural vehicle and the loading arm. The transfer device generally consists of a band or belt conveyer that can receive the product extracted and expelled by the rotary tiller and transport it, by moving it, along the loading arm into the vessel.

The loading arm is mobile vertically from a low position to a high position and reciprocally so that it can position the extraction tool at different heights over the full height of the heading face so that it can effectuate the extraction at its top edge. It is generally mounted for this purpose onto the chassis and/or the vessel in pivoting fashion and/or by translation, being actuated by means of one or several actuators such as at least one hydraulic jack.

Such an extraction vehicle is self-propelled or carried/towed by a towing vehicle. If it is self-propelled, it functions autonomously, i.e. in a robotized or automatic manner without human intervention, or non-autonomously, i.e. by being equipped with a driver's cab controlled by a person and mounted on the self-propelled chassis. The chassis of the self-propelled extraction vehicle is mounted on wheels so that it can move over the ground.

However, a problem encountered during the operation of extraction vehicles, in particular if these vehicles are autonomous, is the presence of an obstacle, such as a person or an animal, on the pile of product(s) that may come into contact with the extraction tool when it is in high position in order to dig into the top edge of the heading face of the pile of product(s). In fact, for example, piles of product(s), such as piles of feed made by silage, are piled up to displace the maximum air so as to maintain good preservation of the feed by preventing the deterioration of its food values and are covered with one or more tarpaulins, generally made of plastic, to maintain the piled feed and to protect it. Ballast items such as tires, flanges or carpets are also placed on the tarpaulins in order to prevent it/them from being lifted by the wind, which would let air in, thereby resulting in the deterioration of the feed. As the feed is consumed, i.e. extracted/loaded by the extraction vehicle, it is then necessary to pull back the tarpaulin(s) after removing the corresponding ballast items from them. This last operation is done manually by the intervention of one or more persons present on the pile of feed and moving over it.

The object of document EP3023004 is an extraction vehicle and more particularly such a vehicle functioning autonomously and comprising data acquisition sensors and/or scanners and a computer for analyzing said data to deduce therefrom the presence of person between the extraction tool and the heading face and in that event to activate an alarm and/or to deactivate the systems such as the extraction tool. More particularly, the computer determines a three-dimensional cloud of points which represents the environment and which is composed of individual points, each position of which is defined by a point coordinate. The cloud represents the individual points of static, dynamic and variable objects detected by the scanner and/or the sensor which were determined at a precise moment.

However, this type of autonomous vehicle described in document EP3023004, on the one hand, is not intended specifically to detect an obstacle present on the pile of product(s) and, on the other hand, uses powerful computerized calculation means necessitating complex data-processing operations using specific software or programs. Moreover, these programs or software do not always give the same information, i.e. reliable information about the height of the pile of product(s) and make it complex to analyze the data, which also increases the cost of the system.

The purpose of the present invention is to mitigate those disadvantages by proposing a process for reliable detection of the top edge of the heading face of a pile of product(s) for animal feeding, from an extraction vehicle and such an extraction vehicle for implementing said process, said process and said extraction vehicle making it possible to obtain reliable information about the height of the top edge of the heading face with a simple analysis of the data and a low cost.

For this purpose, the process, according to the present invention, for reliable detection of the top edge of the heading face of a pile of product(s) for animal feeding, from an extraction vehicle comprising a chassis supporting, at the front of said vehicle, an extraction arm that is vertically mobile and equipped with an extraction tool, is characterized essentially in that it consists, from the vehicle also comprising at least two measurement sensors each oriented toward the front of the vehicle along a measurement axis passing alongside the extraction tool and an electronic processing unit:
in a first phase: of positioning the vehicle in front of the heading face so that the extraction tool is facing the heading face,
in a second phase: of continuously controlling the upward motion of the extraction arm while vertically scanning the plane of the heading face with the axes of measurement in a manner coordinated with the motion of the extraction arm in order to detect the top edge at the moment when the extraction tool reaches or approximately reaches the height of it and while constantly taking, according to a predetermined frequency, using each measurement sensor, a one-time measurement supplying all-or-nothing information, i.e. information indicating the presence or absence of target on the corresponding axis of measurement, as the information indicating the absence of target corresponding to said detection of the top edge,
in a third phase: as soon as at least any information indicating the absence of target is acquired, of ordering the motion of the extraction arm to stop,
in a last phase: of ordering the actuation of the extraction tool for extraction.

The extraction vehicle, according to the present invention, for the extraction of product(s) in a pile of product(s) for animal feeding, said pile of product(s) having a heading face comprising a top edge, said extraction vehicle for implementing the process according to the present invention and comprising a chassis that supports, at the front of said vehicle, an extraction arm that is vertically mobile and equipped with an extraction tool, is characterized essentially in that it also comprises an acquisition chain comprising at least two measurement sensors each oriented toward the front of the vehicle along a measurement axis passing alongside the extraction tool and mounted so as to permit the axes of measurement to follow the motion of the extraction arm in a coordinated manner and an electronic processing unit configured to process the data from the measurement sensors so as to be able, based on the positioning of the vehicle in front of the heading face so that the extraction tool is facing the heading face:
to continuously control the upward motion of the extraction arm while vertically scanning the plane of the heading face with the axes of measurement in a manner coordinated with the motion of said extraction arm in order to detect the top edge at the moment when the extraction tool reaches or approximately reaches the height of it and while constantly taking, at a predetermined frequency, using each measurement sensor, a one-time measurement supplying all-or-nothing information, i.e. information indicating the presence or absence of target on the corresponding axis of measurement, as said information indicating the absence of target corresponding to said detection of the top edge,
as soon as at least any information is acquired indicating the absence of target, to order the motion of the extraction arm to stop,
then to order the actuation of the extraction tool for extraction.

The invention will be better understood, by means of the description below, which refers to a preferred embodiment, given by way of nonrestrictive example, and explained with reference to the attached schematic drawings, in which:

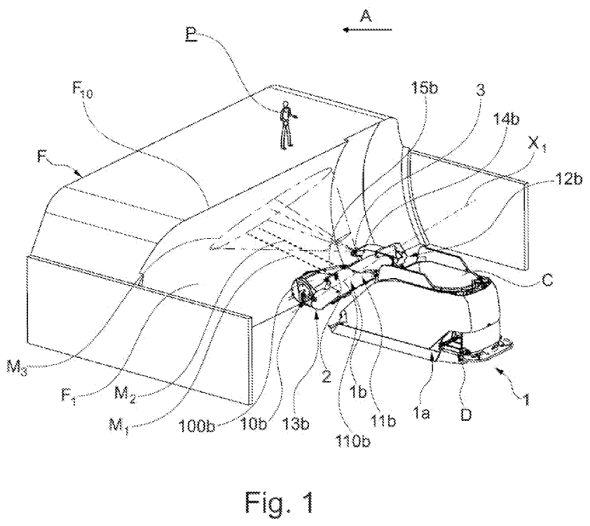

FIG. 1 shows a perspective view of an extraction vehicle according to the present invention, in an autonomous embodiment and positioned, according to the first phase of the process, in front of the heading face of a pile of product(s) to be extracted, with the extraction arm in a low position and the extraction tool stopped, in one preferred embodiment with the measurement sensors affixed to the extraction arm by being mounted on it,

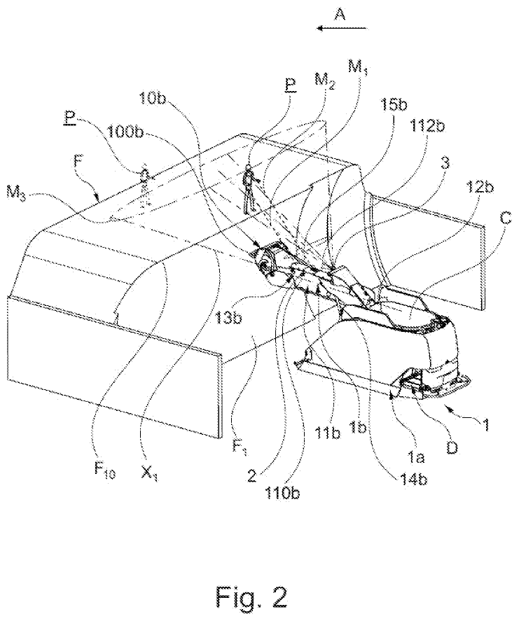

FIG. 2 shows the autonomous extraction vehicle shown in FIG. 1 with the extraction arm moved into a high position corresponding to the acquisition of at least some information of absence of detection, i.e. by at least one of the measurement sensors,

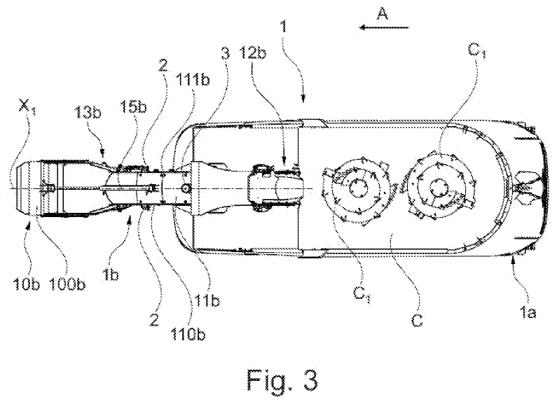

FIG. 3 shows a top view of the extraction vehicle shown in FIG. 1,

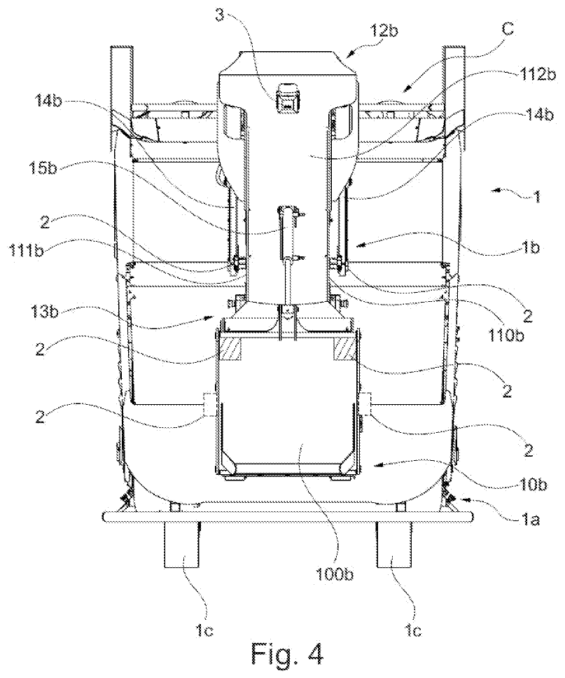

FIG. 4 shows a front view of the front part of the extraction vehicle comprising the extraction arm and shown in FIG. 1 with several possible positions of the measurement sensors,

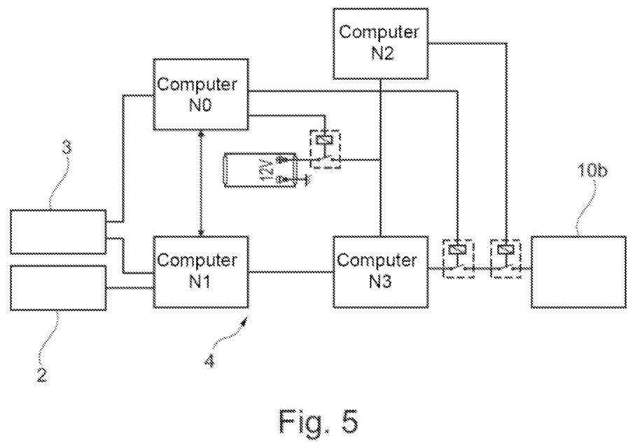

FIG. 5 shows a functional diagram of the acquisition chain.

The attached figures show an extraction vehicle 1, according to the present invention, for extraction or loading of the product(s) F in a pile of product(s) F for animal feeding, said pile of product(s) F having a heading face F1 comprising a top edge F10, said vehicle 1 comprising a chassis 1a that supports, at the front of the vehicle 1, a vertically mobile extraction arm 1b and equipped with an extraction tool 10b. Such a vehicle 1, for example, is described and illustrated in the patent document FR3082699 filed by the present applicant.

Pursuant to the present invention, such a vehicle 1 permits the implementation of the process according to the present invention and also comprises for this purpose an acquisition chain 2, 3, 4 comprising at least two measurement sensors 2 each oriented toward the front of the vehicle 1 following an axis of measurement M1, M2 passing alongside the extraction tool 10b and mounted in said vehicle 1 so as to enable the axes measurements M1, M2 to follow the motion of the extraction arm 1b in a coordinated manner and an electronic processing unit 4.

Still pursuant to the present invention, the electronic processing unit 4 is configured to process the data from the measurement sensors 2 so that it can, from the positioning of the vehicle 1 in front of the heading face F1 such that the extraction tool 10b is facing the heading face F1:
continuously control the upward motion of the extraction arm 1b while vertically scanning the plane of the heading face F10 with the axes of measurement M1, M2 in a manner coordinated with the motion of said extraction arm 1b in order to detect the top edge F10 at the moment when the extraction tool 10b reaches or approximately reaches the height of it and while constantly taking, at a predetermined frequency, using each measurement sensor 2, a one-time measurement supplying all-or-nothing information, i.e. information about the presence or absence of target F1, P on the corresponding axis of measurement M1, M2, as said information indicating the absence of target F1, P corresponding to said detection of the top edge F10,
as soon as at least any information is acquired indicating the absence of target F1, P, order the motion of the extraction arm 1b to stop,
then order the actuation of the extraction tool 10b for extraction.

Axis of measurement M1, M2 passing alongside the extraction tool 10b is understood to mean a measurement axis M1, M2 passing above, below or alongside a lateral side of the extraction tool 10b, preferably, for each case, passing near the extraction tool 10b.

It is understood that said target F1, P is, depending on the height of the extraction arm 1b, either the heading face F1, or an obstacle P located in the vertical continuity of the heading face F1 on its top edge F10 and that the information indicating the absence of target F1, P corresponding to the detection of the top edge F10 means the detection of an absence of target F1, P on the axis of measurement M1, M2 concerned at the time when the extraction tool 10b reaches or approximately reaches the height of the top edge F10.

In one preferred embodiment, as can be seen in FIGS. 1 to 3, of the mounting of the measurement sensors 2 in the vehicle 1 so that the axes of measurement M1, M2 can follow the motion of the extraction arm 1b in a coordinated manner, the measurement sensors 2 can be anchored to the extraction arm 1b, i.e. be mounted in fixed or mobile fashion onto it, the axes of measurement M1, M2 then naturally following the motion of the extraction arm 1b. In another embodiment, not shown in the attached figures, the measurement sensors 2 can be mounted apart from the extraction arm 1b, for example on the chassis 1a or on the vessel C, and each be made mobile , for example by means of a rotating support head or mounted in vertical translation, so as to be able to control the motion of the axes of measurements M1, M2 in a manner coordinated with the motion of the extraction arm 1b from a point of the vehicle 1 located outside said extraction arm 1b.

In the present invention, obstacle P is understood to mean, for example, a person or an animal, and in particular such a person, or animal, present, or moving, on the top of the pile of product(s) F.

Preferably, the acquisition chain 2, 3, 4 can moreover comprise a position sensor making it possible to continuously determine the height of the extraction arm 1b during its vertical motion and the electronic processing unit 4 can then be configured to memorize the height of the extraction arm 1b at the moment when at least some information is acquired detecting the absence of target F1, P. If the extraction arm 1b is mounted in pivoting fashion, as can be seen below, the memorization of the height of the extraction arm can consist of memorizing for example a height or a pivoting angle thereof. That way, at the time of another passage for extraction, the vehicle 1 will not have to repeat the phases of detection of the top edge, but will order the extraction arm 1b to go directly to the memorized height. Advantageously, when the vehicle 1 must lag laterally to continue the loading of product, the phases of detection of the top edge F10 will not be repeated if the operation of repositioning the vehicle 1 and of vertical motion of the extraction arm 1b take place within a short time interval, for example less than one or two minutes. That time interval can be adjustable and can be recorded in the electronic processing unit 4.

To improve the safety of the extraction operation, i.e. the risk of accident when the extraction tool 10b is being actuated at the top edge F10 of the pile of product(s) F, the present invention can provide that the acquisition chain 2, 3, 4 will also comprise at least one presence-detection sensor 3 to be able to detect the presence of an obstacle P, such as a person or an animal, on the pile of product(s) F. The electronic processing unit 4 can then be configured, after having ordered the motion of the extraction arm 1b to stop, to order, using the or each presence sensor 3, the detection of any obstacle P on the pile of product(s) F and if no obstacle P is detected, to order the actuation of the extraction tool 10b.

In one specific embodiment, a one-time measurement can be a measurement of distance between a point of the target F1, P and the corresponding measurement sensor 2. Each measurement sensor 2 can be a distance-measurement sensor 2. Moreover, the acquisition chain 2, 3, 4 can be configured so that any all-or-nothing information will be determined by calculating the difference between the distance measured at a given moment and the distance measured at the previous moment, then by comparing the result of that difference with a reference distance variation value, then, if the result is lower than said reference distance variation value, by supplying information about the presence of target F1, P and, if the result is equal to or greater than said reference distance variation value, supplying information indicating the absence of target F1, P.

The axis of measurement M1, M2 of each measurement sensor 2 is defined by the axis of the radiation, i.e. by an electromagnetic or acoustic radiation, emitted by the measurement sensor 2.

In one preferred embodiment of each distance-measurement sensor 2, it can be, for example, an apparatus of the laser telemeter type. Such an apparatus makes it possible to project onto the target F1, P located within the axis of measurement M1, M2, a laser beam which is bounced back to the apparatus and the time that the ray takes to return is measured, which makes it possible to calculate the distance between the apparatus and the target F1, P, for example using the electronic processing unit 4 or an electronic circuit integrated into the apparatus and connected to said electronic processing unit 4.

As to making constant one-time measurements, at a predetermined frequency, using each measurement sensor 2, said predetermined frequency depends on the technology of the measurement sensor 2 chosen.

The or each presence-detection sensor 3 can consist of an apparatus, for example, of the Radar, ultrasound sensor, camera or LIDAR sensor type. The or each presence-detection sensor 3 is configured and positioned so that the field of detection M3 covers a zone located above the pile of product(s) F when the extraction tool 10b reaches or will reach the level of the top edge F10 of the heading face F1. The presence-detection sensor 3 can be mounted fixedly on the extraction arm 1b or in mobile fashion so as to be able to orient or scan the field of detection M3 of said presence-detection sensor 3 in the zone of detection above the pile of product(s) to cover it. The zone of detection around the pile of product(s) and in particular over the pile of product(s) if thereby broadened due to the presence-detection sensor 3. The risk of accident at the pile of product(s) more particularly at the top edge F10 when the extraction tool 10b is actuated will be very limited or even non-existent.

If we refer to FIG. 2 we can see that the processing unit 4 has ordered the detection of any presence using the presence-detection sensor 3 and that two persons P, one located on the top edge F10 and the other located back from said top edge F10, are located within the field of detection M3 of the presence-detection sensor 3. We can also see that the person P located on the top edge F10, i.e. in the plane of the heading face F1 and in the vertical continuity of the heading face F1, is located on one of the axes of measurement M1 of one of the measurement sensors 2 but not on the other axis of measurement M2 of the other measurement sensor 2, which is due to predefined spacing between the two measurement sensors 2 so that an obstacle P, thus located, will not be simultaneously on the two axes of measurement M1, M2. As to this last person P, the fact that he is located on one of the axes of measurement M1 and not on the other axis of measurement M2 at the same time makes it possible to differentiate that person P from the heading face F1 when detecting the top edge F10 since at least one of the two measurement sensors 2 makes it possible to acquire information indicating that there is no target F1, P.

If we refer to FIGS. 1 to 4, we can see that the measurement sensors 2 are configured and positioned on vehicle 1 so that their respective axis of measurement M1 and M2 is oriented toward the pile of product(s) F or toward the front considering the direction of advancement A of the vehicle 1. The extraction arm 1b is positioned at the front of the vehicle 1. The axes of measurement M1 and M2 are oriented toward the heading face F1 or the plane of the heading face F1 when the extraction arm 1b is in its low position as in its high position.

The two measurement sensors 2 can be positioned on the extraction arm 1b in a manner symmetrical to a median vertical plane passing through the axis X1 of the extraction arm 1b. This feature makes it possible or has the advantage of providing simultaneously, or with a short time lag, the detection of the top edge F10 of the heading face F1. This feature, due to the fact that there is no lag in position of the measurement sensors 2 on the extraction arm 1b, also permits a simplified management thereby avoiding, for example, having to manage offsetting that lag. These advantages make it possible to obtain more reliable and more certain measurements.

According to an alternative not shown, the acquisition chain is configured to comprise three measurement sensors 2. The third measurement sensor 2 can then be positioned between the two measurement sensors 2 positioned symmetrically. This third measurement sensor 2 can be placed, for example, on the axis X1 of the extraction arm 1b and be shifted below or above the axis passing through the measurement sensors 2. This third additional measurement sensor 2 makes it possible to increase reliability.

Alternatively, the two measurement sensors 2 can be positioned on the extraction tool 10b, preferably on the sides of the extraction tool 10b as shown by interrupted lines in FIG. 4. By being positioned on the top part of the sides, the measurement sensors 2 are more distant from each other and the risk of confusing an obstacle P with the top edge F10 is limited. This position closer to the heading face F1 and thus more exposed to the product to be loaded/extracted means that the measurement sensors 2 are, preferably, mounted or protected by a reinforced casing, at least one face of which is transparent so that the axes of measurement M1, M2 can pass through. The present invention can provide for mounting the measurement sensors 2 on the extraction arm 1b in mobile fashion in translation to be able to regulate their spacing and to space them sufficiently apart from each other to reduce said risk of confusion when an obstacle is on the top edge F10.

We can also see in FIGS. 1 and 2 that the axes of measurement M1, M2 of the measurement sensors 2 can be oriented by passing above the extraction tool 10b. The axes of measurement M1, M2, as we can still see on these figures, can be inclined with respect to the axis X1 of the extraction arm 1b.

It is understood that, when the axes of measurement M1, M2 are oriented above or below the extraction tool 10b, there occurs a lag in height between the target F1, P aimed at by said axes of measurement M1, M2 and the extraction tool 10b so that the axes of measurement M1, M2 intercept the top edge F10 of the heading face F1 of the pile of product(s) F before or after the extraction tool 10b is at the same height as said top edge F10. Thus, the present invention can provide that the electronic processing unit 4 is configured to also order an additional motion of the extraction arm 1b upward or downwards to adjust the height of the extraction tool 10b following said lag by bringing it to the height of the top edge F10. This adjustment command can be made when at least some information is obtained that there is no target F1, P so as to order the motion of the extraction arm 1b to stop as soon as the adjustment is made.

In addition, it will be understood that the height of the top edge F10 of the pile of product(s) F from which the extraction is done can vary between two passages of the extraction vehicle 1. In fact, at the time of a first or preceding extraction pass, vehicle 1 may not have extracted, when the extraction tool 1b is lowered from the top edge F10 toward the ground, the full height of the heading face F1, leaving then an intermediate top edge F10 located at an intermediate height between that of the initial top edge F10 and the ground. Thanks to such a vehicle 1 according to the present invention, the extraction tool 10b, at the time of a second or later extraction pass intended to extract the remaining height of product(s) from said intermediate top edge F10, can then be moved and guided, through the motion of the extraction arm 1b, to the height of said intermediate top edge F10 since it will again be able to be detected by the vehicle 1.

Preferably, as can be seen in the attached figures, the two measurement sensors 2 are oriented and spaced from each other, preferably at a distance of, for example, 400 mm to 2500 mm, preferentially about 500 mm, so that a target P formed by an obstacle, such as a person or an animal, located on the top edge F10 and the axis of measurement M1, M2 of one of the measurement sensors 2, cannot be located at the same time on the axis of measurement M1, M2 of the other measurement sensor(s) 2, i.e. detected simultaneously by the other measurement sensor(s) 2. This feature, as seen previously, makes it possible to avoid confusing an obstacle P located on the top edge F10, i.e. in the vertical continuity of the heading face F1, with the heading face F1. This feature more particularly makes it possible to prevent that obstacle P from being detected by all the measurement sensors 2. In fact, in this case no information indicating the absence of target F1, P can then be acquired before the axes of measurement M1, M2 pass over said obstacle P such that the extraction arm 1b would be stopped at too high a height, positioning the extraction tool 10b clearly above the top edge F10, causing a loss of time and thereby energy because of a wrong positioning of the extraction tool 10b. Moreover, in this case, the height of the extraction arm 1b could cause a problem in detection of the obstacles P by the or each presence-detection sensor 3 which would not be oriented in the right direction, said obstacles P then not being detected.

The extraction arm 1b can comprise at least two opposite side faces. Moreover, one of the measurement sensors 2 can be positioned on one of said side faces and the other measurement sensor 2 can be positioned on the other side face. This feature permits or has the advantage of permitting the protection of the measurement sensors 2 by preventing, for example, an object falling onto the extraction arm 1b from colliding with one of the measurement sensors 2, thereby preventing the measurement sensors 2 from being damaged by objects falling or being thrown onto the extraction arm 1b. Furthermore the measurement of the height or the detection of the top edge 10b is all the more reliable since it covers the entire width of the extraction arm 1b.

In a known manner, as can be seen in FIGS. 1 to 4, the vehicle 1 can comprise a vessel C supported by the chassis 1a and the extraction arm 1b can comprise a transfer device 11b making it possible to move the product F extracted by the extraction tool 10b into the vessel C. The transfer device 11b can be laterally delimited along the axis X1 of the extraction arm 1b by two opposite side faces 110b, 111b. One of the measurement sensors 2 can then be positioned on one of the side faces 110b and the other measurement sensor 2 can be positioned on the other side face 111b. This feature enables or has the advantage of providing a reliable, certain measurement. If applicable, said side faces 110b, 111b can form the side faces of the extraction arm 1b, at least partially.

The vessel C can comprise, in a known manner, a mixing device C1 comprising at least one mixing screw. It can also be equipped, as can be seen in FIGS. 1 and 2, in a known manner, with a delivery system D for making possible the distribution of the product(s) F contained in the vessel C. The vessel C can comprise, for example, two mixer devices C1, as can be seen in FIG. 3.

The chassis 1a can be mounted on wheels 10a so that it can move over the ground. The wheels 10a can also be other devices that enable the vehicle to rest on the ground and move over it.

The loading arm 1b can comprise a top face connecting the side faces on which the measurement sensors 2 are positioned and in that the measurement sensors 2 are positioned near said top face. This feature permits or has the advantage of anticipating or better anticipating the detection of the top edge F10 when the extraction arm 1b is rising and thereby saving time.

In one preferred and known form of the motion and mounting of the extraction arm 1b on the chassis 1a, said extraction arm 10b is mounted in pivoting fashion on the vessel C (see in particular FIGS. 1 to 4) and/or on the chassis 1a. The extraction arm 10b comprises for this purpose a proximal end 12b articulated on the vessel C and/or the chassis la, a distal end 13b on which the extraction tool 10b is mounted and at least one actuator 14b to actuate said pivoting. In this embodiment, in particular, the present invention can provide that the measurement sensors 2 are positioned, as can be seen in FIGS. 1 to 4, so as to be closer to the distal end 13b than the proximal end of the extraction arm 1b, preferably in proximity to the distal end 13b. The measurement sensors 2 are positioned so as to be able to detect the heading face F1 of the pile of product(s) F and in particular to scan the heading face F1 vertically with the respective axes of measurement M1, M2.

The extraction tool 10b can comprise a protective hood 100b which can be mounted pivoting on the extraction arm 1b by being articulated on it so as to protect the extraction tool 10b when it is not being used. The actuation or the opening of the protective hood can be effectuated by means of an actuator 15b (FIGS. 1 to 4). According to another alternative, as can be seen in FIG. 4, the measurement sensors 2 can be affixed onto the protective hood 100b, preferably onto the top face of said protective hood 100b (as shown by hatched lines). The protective hood 100b can occupy two positions, i.e. a closed position and an open position. The function of the closed position is to protect the extraction tool 10b and the function of the retracted position is to enable the extraction tool 10b to effectuate the extraction/loading of the product. The protective hood 100b is thereby retracted when the extraction tool 10b is actuated and the extraction is occurring. The measurement sensors 2 can be affixed, preferably, onto the back of the protective hood 100b so as to be a little further away from the extraction zone to avoid receiving projections of product(s) or other projections.

The actuators 14b, 15b can be actuators, well-known in this field, of the jack cylinder type and more specifically double-acting cylinders.

Such a vehicle 1 can be, in a known manner, self-propelled or carried/towed by a towing vehicle (not shown). If it is self-propelled, it can function autonomously, i.e. in a robotized or automatic manner without human intervention (figures attached), or non-autonomously, i.e. with a driver's cab which it can also comprise, operated by a person present in said driver's cab.

As can be seen in FIG. 5, the electronic processing unit 4 can comprise at least a microprocessor, microcontroller or calculator N0, N1, N2, N3 to process the data received from the measurement sensors 2, if applicable from the presence-detection sensor(s) 3, if applicable from the position sensor, and to control, depending on the results of the processing, the actuator(s) 14b, if applicable the actuator(s) 15b and/or, if applicable the motion of the vehicle 1, according to the instructions given by one or more programs contained in said electronic processing unit 4. The electronic processing unit 4 comprises one or more memories for storing, for example, program(s), data, results and the height of the extraction arm 1b at which at least some information is acquired indicating the absence of target F1, P, as well as all data and information necessary for operating the acquisition chain 2, 3.

The object of the present invention is also a process for reliable detection of the top edge F10 of the heading face F1 of a pile of product(s) F for animal feeding, from a vehicle 1. Such a vehicle 1, for implementing the process, can be a vehicle 1 according to the present invention and comprising, as described previously, a supporting chassis 1a at the front of said vehicle 1 and an extraction arm 1b that is mobile vertically and equipped with an extraction tool 10b.

Pursuant to the present invention, the process according to the present invention consists, from such a vehicle 1 according to the present invention also comprising, as described previously, at least two measurement sensors 2 each oriented toward the front of the vehicle 1 following a measurement axis M1, M2 passing alongside the extraction tool 10b and an electronic processing unit 4:
in a first phase: of positioning the vehicle 1 in front of the heading face F10 so that the extraction tool 10b is facing the heading face F1,
in a second phase: of continuously controlling the upward motion of the extraction arm 1b while vertically scanning the plane of the heading face F1 with the axes of measurement M1, M2 in a manner coordinated with the motion of the extraction arm 1b to detect the top edge F10 at the moment when the extraction tool 10b reaches or approximately reaches the height of it and while constantly taking, at a predetermined frequency, using each measurement sensor 2, a one-time measurement supplying all-or-nothing information, i.e. the presence or the absence of a target F1, P on the corresponding axis of measurement M1, M2, as said information indicating the absence of target F1, P corresponding to said detection of the top edge F10. It is understood, as already indicated above, that said target F1, P is, depending on the height of the extraction arm 1b, either the heading face F1, or an obstacle P located in the vertical continuity of the heading face F1 on its top edge F10 and that the information indicating the absence of target F1, P corresponding to the detection of the top edge F10 means the detection of an absence of target F1, P on the axis of measurement M1, M2 concerned at the time when the extraction tool 10b reaches or approximately reaches the height of the top edge F10,
in a third phase: as soon as at least any information is acquired indicating the absence of target F1, P, of ordering the motion of the extraction arm 1b to stop,
in a last phase: of ordering the actuation of the extraction tool 10b for extraction.

In order to provide additional safety before the actuation of the extraction tool 10b, a fourth phase can be done after the third phase and before the last phase. Using at least one presence sensor 3, the fourth phase consists of ordering the detection of the presence of an obstacle P, such as a person or an animal, on the pile of product(s) F and if no obstacle is detected on the pile of product(s) F, effectuating the fifth phase, i.e. ordering the actuation of the extraction tool 10b for extraction.

In one preferred embodiment, using a position sensor to continuously determine the height of the extraction arm 1b when it is in vertical motion, the process can moreover consist of storing, in a memory of the electronic processing unit 4 configured for this purpose, the height of the extraction arm 1b when at least some information is acquired detecting the absence of target F1, P. The position sensor can be positioned functionally in the actuator 14b. Alternatively, the position sensor can be positioned at the level of the articulation pivot of the extraction arm 1b and the chassis 1a of the vehicle and can be, for example, an angle sensor.

If the measurement sensors 2 are distance-measurement sensors 2, such as for example apparatuses of the laser telemeter type, and such that a one-time measurement is a measurement of distance between a point of the target F1, P and the corresponding distance-measurement sensor 2, the process can consist, in order to determine each all-or-nothing information, of calculating the difference between the distance measured at a given moment and the distance measured at the previous moment, then comparing the result of said difference with a reference distance variation value, memorized in the electronic processing unit 4, then, if the result is lower than said reference distance variation value, supplying information about the presence of target F1, P and, if the result is equal to or greater than said reference distance variation value, supplying information indicating the absence of target F1, P.

In the preceding case, the distance variation value can take into account the profile of the heading face F1, in particular when it is inclined or has a sloped or curved part, as can be seen in FIGS. 1 and 2. As visible in those figures, the sides of a pile of product(s) are generally maintained by a wall or partition forming a silo and the pile of product(s) F has a round shape at its top to permit a flow of water when it rains. For example, the distance variation value can be, preferably, between 150 mm and 250 mm or can be preferentially about 200 mm.

It is understood that the plane of the heading face F1 according to the invention comprises the heading face F1, sloped, partly inclined or curved, or not, and the space vertically prolonging said heading face F1 from its top edge F10.

If the vehicle 1 is autonomous, the positioning of the vehicle 1 in front of the heading face F1 so that the extraction tool (10b) is facing the heading face F1 (according to the first phase) can be ordered by the electronic processing unit 4 configured for this purpose or by another electronic processing unit that the autonomous vehicle 1 can contain. If the vehicle 1 is not autonomous, this first phase can be done by the driver. In this last case, the process and/or such a vehicle 1 according to the present invention can be valuable in particular when the driver does not see the obstacle P present on the top edge F10 or on the pile of product(s), for example, because it is back-lit by the sun or a light. This process is still valuable for the driver of the vehicle 1 when the pile of product(s) F is particularly high and an obstacle P on the top edge F10 is not visible from the driver's cab of the vehicle 1.

Before taking the one-time measurements, i.e. before carrying out the various phases, the present invention can also provide for a phase of detection of an obstacle P, such as a person, an animal or an object, that would be located in front of the vehicle 1 and/or the measurement sensors 2. This detection can be done by the or at least one of the presence-detection sensor(s) 3 or by another presence-detection sensor intended specifically for this detection. This specific detection sensor, which is not shown in the attached figures, can for example be positioned under the vehicle 1, for example by being affixed onto the chassis 1a. This detection can be ordered by the electronic processing unit 4 configured for this purpose and connected to said specific detection sensor.

Thus, due to such a vehicle 1 or the process according to the present invention, it is possible to obtain a simple and economical solution of reliable measurement of the height of the top edge F10 of the heading face F1 of a pile of product(s) F, while ensuring the safety of the person(s) P, or an animal or animals present on the pile of product(s) F before the extraction tool 10b is actuated.

Of course, the invention is not limited to the embodiment described and shown in the attached drawings. Modifications are still possible, notably from the standpoint of the make-up of the various components or by substituting technical equivalents, but without departing from the field of protection of the invention.

1. A process for reliable detection of a top edge of a heading face of a pile of product(s) for animal feeding, from an extraction vehicle comprising a chassis supporting, at the front of said vehicle, an extraction arm that is mobile vertically and equipped with an extraction tool, the vehicle also comprising at least two measurement sensors each oriented toward the front of the vehicle along a measurement axis that passes alongside the extraction tool and an electronic processing unit, said method comprising:
in a first phase: positioning the vehicle in front of the heading face so that the extraction tool is facing the heading face,
in a second phase: of continuously controlling the upward motion of the extraction arm while vertically scanning the plane of the heading face with the axes of measurement in a manner coordinated with the motion of the extraction arm in order to detect the top edge at the moment when the extraction tool reaches or approximately reaches the height of it and while constantly taking, according to a predetermined frequency, using each measurement sensor, a one-time measurement supplying all-or-nothing information, said all-or-nothing information indicating a presence or absence of target on the corresponding axis of measurement, as said information indicating the absence of target corresponding to said detection of the top edge,
in a third phase: as soon as at least any information is acquired indicating the absence of target, ordering the motion of the extraction arm to stop,
in a last phase: ordering the actuation of the extraction tool for extraction.

2. The process, according to claim 1, further comprising, using a position sensor to continuously determine the height of the extraction arm during its vertical motion, memorizing in the electronic processing unit configured for this purpose the height of the extraction arm at the moment when at least some information is acquired detecting the absence of target.

3. The process, according to claim 1, wherein the measurement sensors are measurement sensors of distance, and wherein a one-time measurement is a measurement of distance between a point of the target and the corresponding distance-measurement sensor and, in order to determine each all-or-nothing information, wherein said method further comprises calculating the difference between the distance measured at a given moment and the distance measured at the previous moment, then comparing the result of that difference with a reference distance variation value, memorized in the electronic processing unit, then, if the result is lower than said reference distance variation value, supplying information about the presence of target and, if the result is equal to or greater than said reference distance variation value, supplying information indicating the absence of target.

4. An extraction vehicle for the extraction of product(s) in a pile of product(s) for animal feeding, said pile of product(s) having a heading face comprising a top edge, said vehicle for implementing the process according to claim 1, and comprising a chassis that supports at the front of the vehicle an extraction arm that is mobile vertically and equipped with an extraction tool, wherein said vehicle also comprises an acquisition chain comprising at least two measurement sensors each oriented toward the front of the vehicle along an axis of measurement passing alongside the extraction tool and mounted so as to permit the axes of measurements to follow the motion of the extraction arm in a coordinated manner and an electronic processing unit configured to process the data from the measurement sensors so as to be able, from the positioning of the vehicle in front of the heading face so that the extraction tool is facing the heading face:
to continuously control the upward motion of the extraction arm while vertically scanning the plane of the heading face with the axes of measurement in a manner coordinated with the motion of the extraction arm in order to detect the top edge at the moment when the extraction tool reaches or approximately reaches the height of it and while constantly taking, according to a predetermined frequency, using each measurement sensor, a one-time measurement supplying all-or-nothing information, i.e. information indicating the presence or absence of target on the corresponding axis of measurement, as said information indicating the absence of target corresponding to said detection of the top edge,
as soon as at least any information is acquired indicating the absence of target, to order the motion of the extraction arm to stop, then to order the actuation of the extraction tool for extraction.

5. The extraction vehicle, according to claim 4, wherein the acquisition chain also comprises a position sensor for continuously determining the height of the extraction arm during its vertical motion and wherein the electronic processing unit is configured to memorize the height of the extraction arm at the moment when at least some information is acquired detecting the absence of target.

6. The extraction vehicle, according to claim 4, wherein a one-time measurement is a measurement of distance between a point of the target and the corresponding measurement sensor and that each measurement sensor is a distance-measurement sensor such as, for example, an apparatus of the laser telemeter type.

7. The extraction vehicle, according to claim 6, wherein the acquisition chain is configured so that the all-or-nothing information is given by calculating the difference between the distance measured at a given moment and the distance measured at the previous moment, then by comparing the result of that difference with a reference distance variation value, then, if the result is lower than said reference distance variation value, by supplying information about the presence of target and, if the result is equal to or greater than said reference distance variation value, supplying information indicating the absence of target.

8. The extraction vehicle, according to claim 4, wherein the two measurement sensors are positioned on the extraction arm symmetrically with respect to a median vertical plane passing through the axis of the extraction arm.

9. The extraction vehicle, according to claim 4, wherein the two measurement sensors are oriented and spaced from each other so that a target made up of an obstacle located on the top edge and on the axis of measurement of one of the measurement sensors cannot be located at the same time on the axis of measurement of the other measurement sensor(s).

10. The extraction vehicle, according to claim 4, further comprising a vessel supported by the chassis and the extraction arm comprises a transfer device for moving the product extracted by the extraction tool into the vessel, said transfer device being delimited laterally along the axis of the extraction arm by two opposite side faces and wherein one of the measurement sensors is positioned on one of said side faces and the other measurement sensor is positioned on the other side face.

11. The extraction vehicle, according to claim 4, wherein the extraction arm is mounted in pivoting fashion on the chassis and/or the vessel and comprises a proximal end articulated on the chassis and/or the vessel, a distal end on which the extraction tool is mounted and at least one actuator to actuate said pivoting and wherein the measurement sensors are positioned so as to be closer to the distal end than the proximal end.

12. The extraction vehicle, according to claim 4, wherein said vehicle is autonomous and wherein the positioning of the vehicle in front of the heading face so that the extraction tool is facing the heading face is controlled by the electronic processing unit configured for this purpose or by another electronic processing unit that the autonomous vehicle may contain.
